(19) United States
(12) Patent Application Publication
(10) Pub. No.: US 2007/0006232 A1
(43) Pub. Date: Jan. 4, 2007

(54) Method and system for a ticket lock using a dynamically reconfigurable distributed polling area

(76) Inventor: Brian E. Bliss, Tolono, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,775

(22) Filed: Jun. 30, 2005

(51) Int. Cl. G06F 9/46

(52) U.S. Cl. 718/100

(57) ABSTRACT

A method and system for a ticket lock implementation using a dynamically reconfigurable distributed polling area is described. The method includes polling a memory location for a value to indicate whether one of a plurality of threads may have exclusive access to a section of code, periodically checking a mapping of values to polling locations to determine whether the mapping is to be changed, and locking the memory location when the value indicates that the thread may have exclusive access to the section of code.

### TECHNICAL FIELD

Embodiments of the invention relate to multiprocessor synchronization, and more specifically to ticket locking using a dynamically reconfigurable distributed polling area.

### BACKGROUND

When there are multiple threads executing simultaneously, a synchronization mechanism is used to ensure that different threads read and write selected regions of memory in a coherent fashion. A locking mechanism, also known as a mutex, assures mutual exclusion to certain sections of code. These sections of code are often referred to as critical sections, where at most one thread may execute the code fragment at a time. A ticket lock is one implementation where a thread uses a low-level atomic synchronization primitive to obtain a ticket value, then waits until a counter reaches that value, or some function of the value. For example, a fetch-and-increment instruction may be used to read a memory location and increment its value, while no other thread or processor is able to access the memory location in between. The thread then waits for another counter to reach the ticket value, and enters the critical section. By program design, the thread will typically be guaranteed exclusive access to certain data objects protected by the lock. When the thread is done and wishes to allow other threads access to the data objects, it increments the counter to allow the next thread in line exclusive access. If no threads are waiting, then the next thread to try to obtain the lock will be given exclusive access.

In another method, the thread polls the memory location for a change in value and issues shared read memory requests until it is determined that the lock is free. This reduces the number of exclusive memory requests, but multiple atomic instructions may still be issued while trying to obtain a lock that has significant contention, since other threads may obtain the lock before the thread in question can complete the atomic instruction. In a ticket lock using a single memory location for the counter, the repeated invalidations of the cache line being polled to release the lock cause unnecessary overhead as other processors are polling the same lock, but are not next in line to obtain it.

To solve this problem, a distributed polling area may be used. In a method utilizing a fully distributed polling area, every thread polls a different location. However, this method requires that the upper bound on the number of threads is known in advance. On many systems, especially where the number of threads exceeds the number of processors, an upper bound on the number of threads is large enough that it causes the size of the polling area to impede performance.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating a suitable computing environment in which certain aspects of the illustrated invention may be practiced.

FIG. 2 is a flow diagram illustrating a method according to an embodiment of the invention.

### DETAILED DESCRIPTION

Embodiments of a system and method for a ticket lock implementation using a dynamically reconfigurable distributed polling area are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

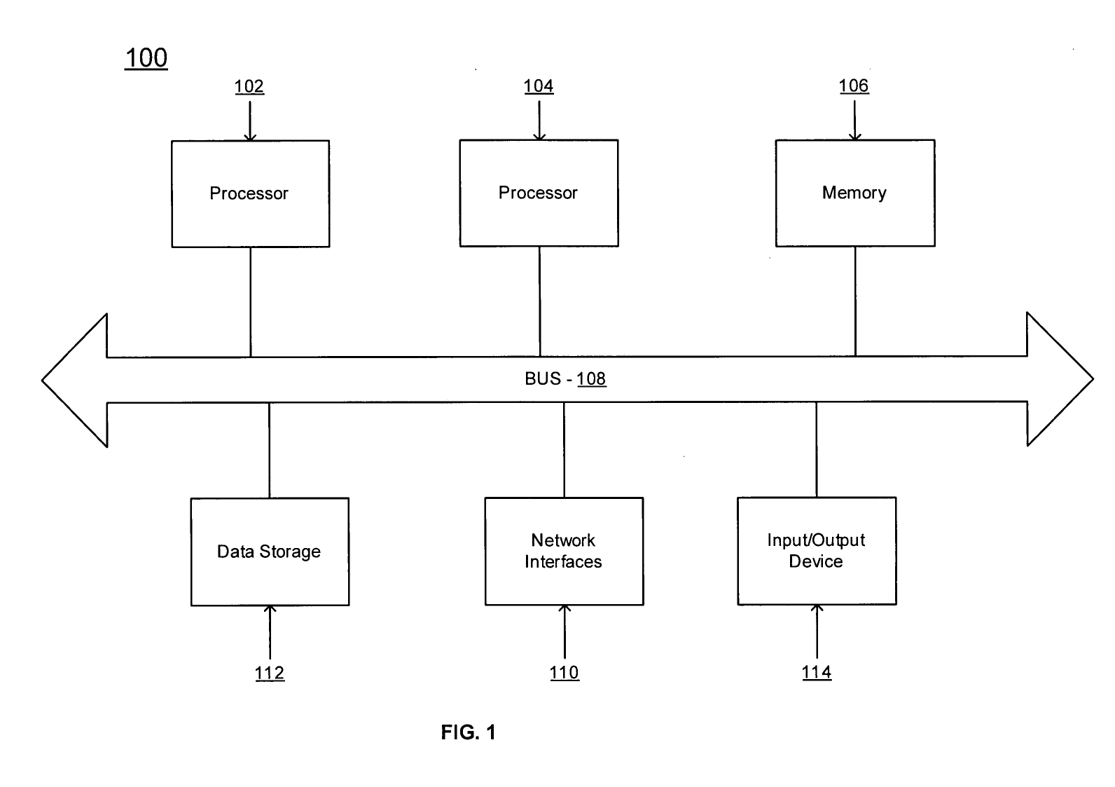

FIG. 1 is a block diagram illustrating a suitable computing environment in which certain aspects of the illustrated invention may be practiced. Methods of the invention may be implemented on a computer system 100 having components that include a plurality of processors, such as 102 and 104, a memory 106 shared by two or more of the processors, an Input/Output device 114, a data storage device 112, and a network interface 110, coupled to each other via a bus 108. The components perform their conventional functions known in the art and provide the means for implementing the system 100. Collectively, these components represent a broad category of hardware systems, including but not limited to general purpose computer systems, mobile or wireless computing systems, and specialized packet forwarding devices. It is to be appreciated that various components of computer system 100 may be rearranged, and that certain implementations of the present invention may not require nor include all of the above components. Furthermore, additional components may be included in system 100, such as additional processors, storage devices, memories (e.g. RAM, ROM, or flash memory), and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

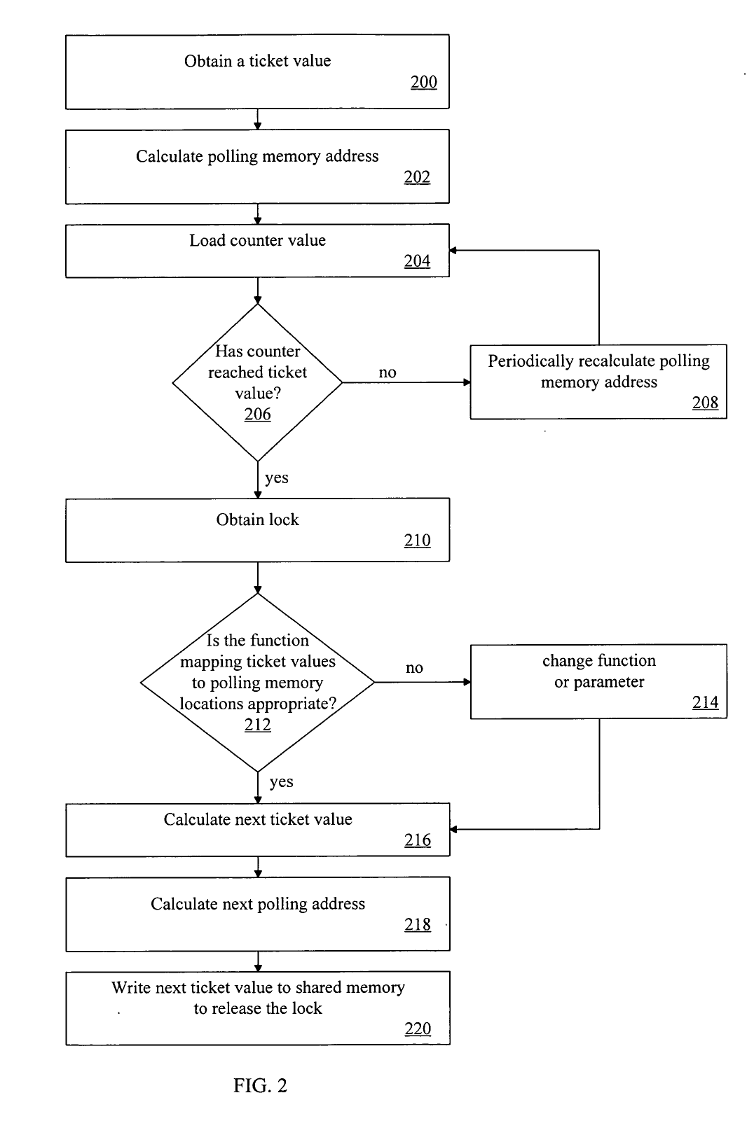

FIG. 2 illustrates one embodiment of the invention. A thread or processor waiting for exclusive access to a section of code may poll a memory location for a ticket value. At 200, a ticket value is obtained. In one embodiment, a synchronization primitive, such as a fetch and increment atomic synchronization primitive, is used to obtain the ticket value. Using this atomic synchronization primitive, a memory location is read and its value incremented. In one embodiment, no other thread or processor is able to access to the memory location in between the time the memory location is read and the incremented value is written.

At 202, the polling memory address is calculated. In one embodiment, the polling memory address represents the address or value of a counter that will poll for the ticket value. At 204, the counter value is loaded. At 206, a determination is made as to whether the counter value has reached the ticket value. In one embodiment, a determination is made as to whether a function of the ticket value has been reached. If not, then the thread or processor waiting for exclusive access to the memory location continues to wait. While waiting, at 208, the polling memory address or address of the counter may be periodically recalculated. If the polling area or the function mapping ticket values to polling memory locations changes while the thread or processor is waiting, then the polling memory address is recalculated and a different memory location may be polled. After the polling memory address is recalculated, at 204, the counter value may be reloaded. When the counter has reached the ticket value, then at 210, the lock is obtained and the thread or processor is given exclusive access to the section of code, which is also known as the critical section. The user's work may be performed in the critical section, anywhere between 210 and 220. Exclusive access is maintained until the lock is released by writing the next ticket value to the memory location, where the thread next in line to enter the critical section will poll, or is already polling.

In one embodiment, writing the ticket value instead of a sentinel allows more than one thread to poll the same location. A partially distributed polling area is one utilizing more than one memory location for polling, but each thread does not necessarily poll a unique memory location. This allows for a partially distributed polling area to be smaller than a fully distributed polling area, typically with a size (in cache lines) nearer to the number processors, instead of having a large upper bound on the number of threads.

At 212, the function mapping ticket values to the polling memory locations is checked to determine whether it is appropriate. If not, then at 214, the function or a parameter of the function may be changed. In one embodiment, a new polling area may be allocated or the current polling area extended, contracted, or reshuffled. When the polling area changes, the function mapping the ticket values to the polling locations is changed accordingly. The waiting threads or processors periodically recalculate and reload the mapping function at 208 and 204. Therefore, if the mapping function is changed while a thread or processor is waiting, the changed mapping is reloaded by the waiting threads, and a different memory location may be polled.

In one embodiment, during the evaluation of the mapping function at 212, the number of threads or processors that are waiting for exclusive access to the memory location is determined. If the number of threads or processors that are waiting is greater than the size of the polling area, the polling area may be expanded. If the number of threads or processors waiting is less than the size of the polling area, the polling area may be contracted. If the polling area is resized, the mapping function is modified accordingly. Then, the threads that are waiting may reload the new mapping function and poll in the modified polling area.

At 216, the next ticket value is calculated. At 218, the address that the next thread or processor will poll for the next ticket value is calculated. At 220, the next ticket value is written to shared memory to release the lock.

Once the lock is released, the next thread or processor waiting in line may obtain the lock. If no threads or processors are waiting, then the next thread or processor to try to obtain the lock will be given a ticket value which is equal to the value the current thread or processor stores to the polling area. The next thread or processor will load the value from the polling area, find that it is equal to its ticket value, and obtain the lock.

The following examples (written in a syntax similar to the programming language C) are provided for illustrative purposes. The first example is of a partially distributed polling area. The ticket lock in this example allows the number of threads to exceed the number of polling locations. In this example, the polling area is an array and the mapping function indexes the array by taking the ticket value modulo the table size. Other mapping functions and polling area representations may be used. In this example, the ticket value is written to the memory location. Writing the ticket value allows for a partially distributed polling area in which several threads with different ticket values may poll the same location. In other embodiments, other values, such as a sentinel, value may be written to the memory location.

typedef struct lock_t { int acq_ctr, pad1[], rel_ctr, pad2[],
size, *polls; } lock_t;
void lock(lock_t *lck) {

int val = fetch_and_increment(&(lck−>acq_ctr));
while (lck−>polls[val mod lck−>size] < val);

}
void unlock(lock_t *lck) {

int val = + + lck−>rel_ctr;
atomic_write(&(lck−>polls[val mod lck−>size]), val);

}

In the above example, a structure is defined with an acquire counter (acq_ctr), a release counter (rel_ctr), a polling area size (size), a polling area (*polls), and some space in between for padding (pad1 and pad2) to ensure that the counters are on separate cache lines. A fetch-and-increment synchronization primitive is called. A lock value (val) is returned and the acquire counter is incremented. The lock value is compared to the ticket value. Once the lock value reaches the ticket value, the thread is given exclusive access to the memory location. In this example program, no other thread or processor will be given access the data objects protected by the lock between the time the lock is obtained and the time the lock is released. To release the lock, the next ticket value is calculated, the location to write in the polling area is calculated, and the counter value is written in a way that it is made available to the other threads.

The next example is of a ticket lock with a dynamically reconfigurable polling area. In this example, the polling area is an array and the mapping function indexes the array by taking the ticket value modulo the table size. Other mapping functions and polling area representations may be used.

typedef struct lock_t { int acq_ctr, pad1[line_size-1],
rel_ctr, pad2[line_size-1],

size, *polls; }

int (*calculate_address_to_poll)(int, lock_t *);
void lock(lock_t *lck) {

int val = fetch_and_increment(&(lck−>acq_ctr));
while ((*calculate_address_to_poll)(val, lck) < val);

int num_waiting = lck−>acq_ctr − lck−>rel_ctr;
if (size_is_inappropriate(lck−>size, num_waiting) {

```
  int (*new_func)(int, int), *new_polls;
  lck−>size = calculate_appropriate_size(lck−>size,
  num_waiting);
  new_polls = reconfigure_polling_area(&new_func,
  lck−>size, lck−>polls);
atomic_write(&(lck−>polls), new_polls);
  atomic_write(&calculate_address_to_poll, new_func);
```

}

}
void unlock(lock_t *lck) {

int val = lck−>rel_ctr + +;
int *poll = (*calculate_address_to_poll)(val, lck);
atomic_write(poll, val);

}

In the above example, the polling table data structure and the function mapping the ticket values to the polling locations are periodically checked. If the polling area is determined to be inappropriate, a new polling area may be allocated or the current polling area may be extended, contracted, or reshuffled. The function mapping the ticket values to the polling locations may then be changed. While the thread waits for the ticket value to be reached, it will periodically reload the “calculate address to poll” function. Alternatively, or additionally, a parameter to a function or a function pointer may be modified and reloaded. If the polling area function mapping changes, the new polling location will be recalculated. In this way, the polling area may be dynamically reconfigured.

The number of processors waiting is also checked. If there are too many processors waiting, then the size of the polling area may be changed, such as by allocating more memory for this polling area. The size of the polling area may also be decreased. After the polling area is changed, the mapping function is changed accordingly, so that the processors that are waiting will reload the modified function.

In this example, the pointer to the polling area and the mapping function are written independently. This is allowed in this example since unique ticket values are written to the polling area, and not sentinels. In other embodiments, the reconfigured polling area and mapping function must both be written as a single atomic unit.

The following example is for a more specific implementation of the previous example, where the arithmetic is performed using 64 bit integers and the cache line size is 128 bytes.

typedef long long word;
typedef struct lock_t {

| word next_acq; | // acquire ticket counter |
|---|---|
| word pad1[15]; | |
| word next_rel; | // release ticket counter |
| word pad2[15]; | |
| word num_polls; | // size of polling area |
| | used (in cache lines) |
| word mask; | // mask for modulo |

operation

word pad3[14];
struct {

| | |
|---|---|
| word poll; | // poll location |

word pad4[15];

} polls[MAX_POLLS];

} lock_t;
volatile lock_t the_lock;
void lock(volatile lock_t *lck) {

| | |
|---|---|
| word val = fetch_and_increment | // acquire |
| (&(lck−>next_acq)); | ticket |

| word index = val & lck−>mask; // | |
|---|---|
| poll index = ticket value modulo table size | |
| if (lck−>polls[index].poll != val) { | // quickly check poll area |
| | first time |
| for (;;) { | // we need to poll wait |

for (int i = 0; i <
RELOAD_FREQ; i + +)

if (lck−>polls[index].poll = =
val)

goto done;

| | |
|---|---|
| index = val & lck−>mask; | // recalculate poll |

location

| } | |
|---|---|
| } | |
| done: | // lock has been acquired |
| | // start of critical section |
| lck−>next_rel = val; | // save ticket val for use |
| | by unlock( ) |
| word size = lck−>next_acq − val; | // ideal size of table = |

num_waiting + 1

if (size > MAX_POLLS) {

| | |
|---|---|
| size = MAX_POLLS; | // can't go over size of |

| | allocated array |
|---|---|
| } | |
| word num_polls = lck−>num_polls; | |
| if (num_polls < size) { | // check if we need to |

| | reconfigure poll area |
|---|---|
| word mask = lck−>mask; | |
| while (num polls < size) { | // double num_polls until |

it's big enough

| num_polls * = 2; | |
|---|---|
| mask = (mask < < 1) \| 1; | //recalculate mask |

| } | |
|---|---|
| lck−>num_polls = num_polls; | //save new num_polls |

and mask

lck−>mask = mask;

}

}
void unlock(volatile lock_t *lck) {

word val = lck−>next_rel + 1;
atomic_store(&(lck−>polls[val & lck−>mask].poll), val);

}

Thus, embodiments of a system and method for a ticket lock implementation using a dynamically reconfigurable distributed polling area has been described. While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
polling a memory location for a value to indicate whether one of a plurality of threads may have exclusive access to a section of code;
periodically checking a mapping of values to polling locations to determine whether the mapping is to be changed; and
acquiring a lock to the memory location when the value indicates that the thread may have exclusive access to the section of code.

2. The method of claim 1, further comprising changing the mapping of values to polling locations.

3. The method of claim 2, further comprising reloading the changed mapping.

4. The method of claim 3, further comprising polling a different memory location after reloading the changed mapping.

5. The method of claim 1, further comprising further comprising releasing the lock when the thread is done with the section of code.

6. The method of claim 1, wherein polling a memory location comprises calling a fetch and increment synchronization primitive.

7. The method of claim 1, further comprising determining how many threads are waiting for exclusive access to the section of code.

8. The method of claim 1, further comprising determining whether a polling area should be resized based on how many threads are waiting for exclusive access to the section of code.

9. A system comprising:
a plurality of processors;
a network interface coupled to the plurality of processors; and
a memory coupled to and shared by two or more of the plurality of processors, wherein one of the processors sharing the memory is to poll a location of the memory for a value to indicate whether the processor may have exclusive access to a section of code and to periodically check a mapping of values to polling locations to determine whether the mapping is to be changed.

10. The system of claim 9, wherein the processor to poll the memory location is to further lock the memory location when the value indicates that the processor may have exclusive access to the section of code.

11. The system of claim 9, wherein one of the plurality of processors to change the mapping of values to polling locations.

12. The system of claim 11, wherein one or more of the plurality of processors that are waiting to have exclusive access to the section of code to reload the changed mapping.

13. An article of manufacture comprising:
a machine accessible medium including content that when accessed by a machine causes the machine to perform operations comprising:
polling a memory location for a value to indicate whether one of a plurality of processors may have exclusive access to a section of code;
periodically checking a mapping of values to polling locations to determine whether the mapping is to be changed; and
locking the memory location when the value indicates that the processor may have exclusive access to the section of code.

14. The article of manufacture of claim 13, wherein the machine-accessible medium further includes content that causes the machine to perform operations comprising changing the mapping of values to polling locations.

15. The article of manufacture of claim 14, wherein the machine-accessible medium further includes content that causes the machine to perform operations comprising reloading the changed mapping.

16. The article of manufacture of claim 15, wherein the machine-accessible medium further includes content that causes the machine to perform operations comprising polling a different memory location after reloading the changed mapping.

17. The article of manufacture of claim 13, wherein the machine-accessible medium further includes content that causes the machine to perform operations comprising releasing the locked memory location when the processor is done with the section of code.

18. The article of manufacture of claim 13, wherein the machine-accessible medium further includes content that causes the machine to perform operations comprising calling a fetch and increment synchronization primitive.

19. The article of manufacture of claim 13, wherein the machine-accessible medium further includes content that causes the machine to perform operations comprising determining how many processors are waiting for exclusive access to the section of code.

20. The article of manufacture of claim 19, wherein the machine-accessible medium further includes content that causes the machine to perform operations comprising determining whether a polling area should be resized based on how many processors are waiting for exclusive access to the section of code.
